(19) United States
(12) Patent Application Publication
(10) Pub. No.: US 2012/0121268 A1
(43) Pub. Date: May 17, 2012

(54) Method And Apparatus Of Microwave Photonics Signal Processing

(76) Inventors: Young-Kai Chen, Berkeley Heights, NJ (US); Kun-Yii Tu, Califon, NJ (US); Michael George Zierdt, Hillsborough, NJ (US)

(21) Appl. No.: 13/353,579

(22) Filed: Jan. 19, 2012

Related U.S. Application Data
(63) Continuation of application No. 12/384,006, filed on Mar. 31, 2009.

(51) Int. Cl. H04B 10/02

(52) U.S. Cl. 398/115

(57) ABSTRACT

A radiofrequency (rf) signal-processing device offers the possibility of high bandwidth operation. The disclosed device applies principles of microwave photonics and Linear Amplification based on Nonlinear Components (LINC). For some applications, the device may be embodied in an rf amplifier or rf transmitter. In an embodiment, an optical phase modulator is configured to receive an optical carrier signal as input, and further configured so that, when driven by an rf modulation signal, it will produce a complementary pair of optical signals as output. Each of a pair of detectors is configured to convert a respective one of the complementary optical signals to an rf signal. An rf combiner is configured to add the converted radiofrequency signals from the detectors to form an output signal.

### FIELD OF THE INVENTION

The invention relates to processing of radiofrequency signals.

### ART BACKGROUND

Devices for processing radiofrequency (rf) signals are essential for telecommunications and other applications. In designing or selecting signal processing devices for particular rf applications, practitioners often encounter tradeoffs among factors such as bandwidth, efficiency, linearity, and cost. Such tradeoffs are encountered, for example, when designing or selecting power amplifiers for use in wireless communication systems.

As the demands on wireless networks, for example, continue to increase, there is a growing need for equipment that achieves favorable balances among these factors. For this reason, among others, there is a need for new rf signal-processing hardware that achieves improvements in at least some of these factors.

### SUMMARY OF THE INVENTION

We have developed a radiofrequency (rf) signal-processing device that offers the possibility of high bandwidth operation. Our new device applies principles of microwave photonics and Linear Amplification based on Nonlinear Components (LINC). For some applications, accordingly, our invention may be embodied in an rf amplifier or rf transmitter.

In an embodiment, our invention comprises an optical phase modulator. The modulator is configured to receive an optical carrier signal as input. Moreover, the modulator is configured so that, when driven by an rf modulation signal, it will produce a complementary pair of optical signals as output. The embodiment further comprises a pair of detectors, each of which is configured to convert a respective one of the complementary optical signals to an rf signal, and an rf combiner configured to add the converted radiofrequency signals from the detectors, so as to form an output signal.

In some embodiments, the modulator is configured to apply the rf modulation signal to the optical carrier signal as a differential pair of complementary radiofrequency signals.

Some embodiments further comprise a medium arranged to guide the complementary optical signals from the modulator to the detectors. In some such embodiments, the medium is configured to bring the complementary optical signals into phase at the detectors.

Some embodiments further comprise at least one component configured to admit an optical reference signal to the medium, such that at the detectors, each of the complementary optical signals is combined with the optical reference signal.

Some embodiments further comprise an amplitude-to-phase converter configured to provide a phase-converted signal as the radiofrequency modulation signal for driving the optical phase modulator.

Some embodiments comprise a method for processing an optical carrier signal by performing the functions of, e.g., the elements described above.

### BRIEF DESCRIPTION OF THE DRAWING

FIG. 1 is a schematic drawing of a signal-processing device according to an embodiment of the invention.

FIG. 2 is a schematic drawing of an embodiment of the invention configured as a radiofrequency transmitter.

### DETAILED DESCRIPTION

The principles of LINC are known. Consider a carrier frequency ω and a time-varying signal a(t) which varies slowly relative to cos(ωt+θ), where θ is an arbitrary phase angle. Let Aₘₐₓ be the magnitude of the maximum positive or negative excursion of a(t); i.e., Aₘₐₓ=max|a(t)|. The phase function φ(t) is constructed from a(t) according to the transformation,

$$\frac{1}{2} φ ( t ) = {cos}^{- 1} ( \frac{a ( t )}{{A}_{max}} ) .$$

A simple trigonometric identity can now be invoked to show that the amplitude-modulated signal a(t) cos(ωt+θ) can be expressed as the sum of two constant-amplitude, phase-modulated signals; i.e.,

$$a ( t ) cos ( ω t + θ ) = \frac{{A}_{max}}{2} cos ( ω t + θ + \frac{1}{2} φ ( t ) ) + \frac{{A}_{max}}{2} cos ( ω t + θ - \frac{1}{2} φ ( t ) ) .$$

Those skilled in the art of power amplification for wireless communication, among others, have recognized that tradeoffs exist among efficiency, linearity, and bandwidth. In particular, the conventional amplification of amplitude-modulated signals having large peak-to-average power ratios may test the limits of favorable tradeoffs among those factors. To overcome such disadvantages, it has been proposed to decompose amplitude-modulated signals into pairs of phase-modulated signals, and to separately amplify the decomposed signals before recombining them to recover a linearized output signal. In this regard, a linearized output signal is an amplified output signal that is proportional to the input signal, excluding residual nonlinearities of the amplification system.

Because each of the signals to be amplified has an amplitude constrained to lie within a sinusoidal envelope (with a time-varying phase), high-efficiency, nonlinear power amplifiers can be used without unacceptably distorting the signal. Thus, it has been proposed, a highly favorable tradeoff may be obtained between efficiency and linearity. The principles of such an amplifier are referred to as LINC.

We have found a way to implement LINC principles using phase modulation in a microwave photonic component. In general, photonic phase modulators are inherently extremely high-bandwidth devices. For that reason, we believe that implementations of our microwave photonic LINC device will be able to achieve highly favorable bandwidth performance, as well as high linearity and high efficiency.

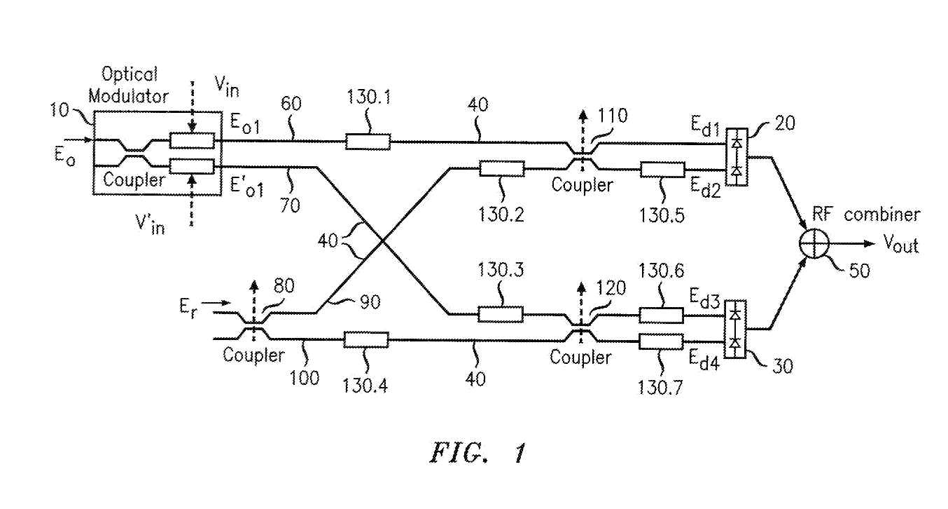

Reference to FIG. 1 shows an example in which optical modulator 10 is optically coupled to detectors 20 and 30 through waveguiding medium 40. It will be seen that the rf outputs from detectors 20 and 30 are directed to rf combiner 50, where they are combined to form an output voltage signal Vₒᵤₜ.

As seen in the figure, an optical carrier signal E₀=E₀e^{jω}^{₀}^{t+θ}^{₀} is applied to the input port of modulator 10. The modulation signal applied to modulator 10 is shown as the complementary pair Vᵢₙ(t), V′ᵢₙ(t). Making reference to the signal a(t) that is to be amplified and to its phase-transformed version φ(t), and letting V_{π} represent the modulation voltage that produces a phase change of π radians, the modulation signals are defined by

$${V}_{in} ( t ) = ( \frac{{V}_{π}}{π} ) φ ( t ) , {V}_{in}^{′} ( t ) = - ( \frac{{V}_{π}}{π} ) φ ( t ) .$$

Thus, the oscillatory components of these complementary signals are 180 degrees out of phase. (Disregarded here is a common dc voltage that Vᵢₙ(t) and V′ᵢₙ/(t) may share.)

Various sources may be used to provide the optical carrier signal. One exemplary such source is an optical fiber laser.

The exemplary optical modulator shown in the figure as modulator 10 is of the planar waveguide kind, in which a 2×2 optical coupler has two parallel output branches, each coupled to a phase-modulation stage which may, for example, be a high-frequency lithium niobate or indium phosphide modulator. In such an arrangement, it will be seen that each of the two complementary modulation signals is applied to one of the parallel modulation stages, thereby producing two complementary modulated optical signals E₀₁ and E′₀₁, respectively. It will be seen further that each modulation stage provides output to a respective branch 60, 70, of the waveguiding medium, in which branch 60 is shown in the figure as an upper branch, and branch 70 as a lower branch.

It will be seen further that upper branch 60 communicates with detector 20, whereas lower branch 70 communicates with detector 30. Exemplary detectors are balanced photodiode detectors, as shown schematically in the figure. The use of balanced detectors is advantageous because such detectors tend to reject common-mode optical noise.

Those skilled in the art will understand that the frequency of the optical carrier signal, which may for example be several hundred terahertz, is much greater than the frequency of the desired output rf signal, which may typically lie in the range from several hundred megahertz to several tens of gigahertz. Downshifting from optical to radio frequency is achieved by providing an optical reference signal that interferes with the optical carrier at the detectors.

More specifically, it will be seen in FIG. 1 that optical reference signal Eᵣ=Eᵣe^{jω}^{ᵣ}^{t+θ}ᵣ having frequency ωᵣ and phase θᵣ is introduced via optical coupler 80. From one output port of coupler 80, the reference signal is guided via branch 90 of the waveguiding medium toward detector 20, and from the other output port of the coupler, the reference signal is guided via branch 100 of the waveguiding medium toward detector 30.

Various sources may be used to provide the optical reference signal. One exemplary source for the optical reference signal is a solid-state laser, injection-locked to the carrier source so that it operates as a slave laser. More specifically, a portion of the output from the optical carrier source is tapped off and used to inject the reference source. Radiofrequency modulation of the injected light from the carrier source can be used to cause the slave laser to oscillate at a tunable frequency offset from the optical carrier frequency.

It will be seen further that the reference signal combines with modulated optical signal E₀₁ at optical coupler 110, and with modulated optical signal E′₀₁ at optical coupler 120. Interference between the reference signal and the modulated carrier signal produces a waveform having a phase-modulated envelope whose frequency is the beat frequency ω₀-ωᵣ, and having a phase of

$$\pm \frac{φ ( t )}{2} + θ ,$$

where θ is the difference between θ₀ and θᵣ .

It will be seen further that seven optical phase shifters numbered from 130.1 to 130.7 are shown in the figure as part of the waveguiding medium. When the various phase shifts in the medium are adjusted appropriately, the rf output signal Vₒᵤₜ from rf combiner 50 will have the form

$${V}_{out} = {R}_{out} \{ {E}_{0} {E}_{r} cos [ ( {ω}_{0} - {ω}_{r} ) t + \frac{φ ( t )}{2} + θ ] + {E}_{0} {E}_{r} cos [ ( {ω}_{0} - {ω}_{r} ) t - \frac{φ ( t )}{2} + θ ] \} ,$$

where Rₒᵤₜ represents the load resistance of the detector, or the trans-impedance of an amplifier that may be used after the detector to facilitate current-to-voltage conversion.

According to the trigonometric identity referred to above, Vₒᵤₜ can be rewritten as

$${V}_{out} = {R}_{out} {E}_{0} {E}_{r} \frac{2 a ( t )}{{A}_{max}} cos ( {ω}_{0} - {ω}_{r} ) t .$$

(The phase term θ has been omitted to simplify the expression.)

Thus, the output Vₒᵤₜ is an amplitude-modulated rf signal whose center frequency is the difference between the optical carrier and reference frequencies. Vₒᵤₜ may be subjected to further signal processing and conditioning, or it may be applied directly to an antenna for transmission.

One set of values for the respective phase shifts 130.1 to 130.7 that is useful in this regard is:

$$0 , \frac{3 π}{2} , 0 , \frac{3 π}{2} , \frac{3 π}{2} , 0 , \frac{3 π}{2}$$

radians. It will be understood in this regard that maintaining good synchronization between the modulated signals E₀₁ and E′₀₁ is desirable in order to obtain an output signal of good quality. Variable phase shift components are advantageously employed to compensate for relative time delays in the various branches of the optical medium. Known feedback techniques may additionally be employed to stabilize the relative time delays.

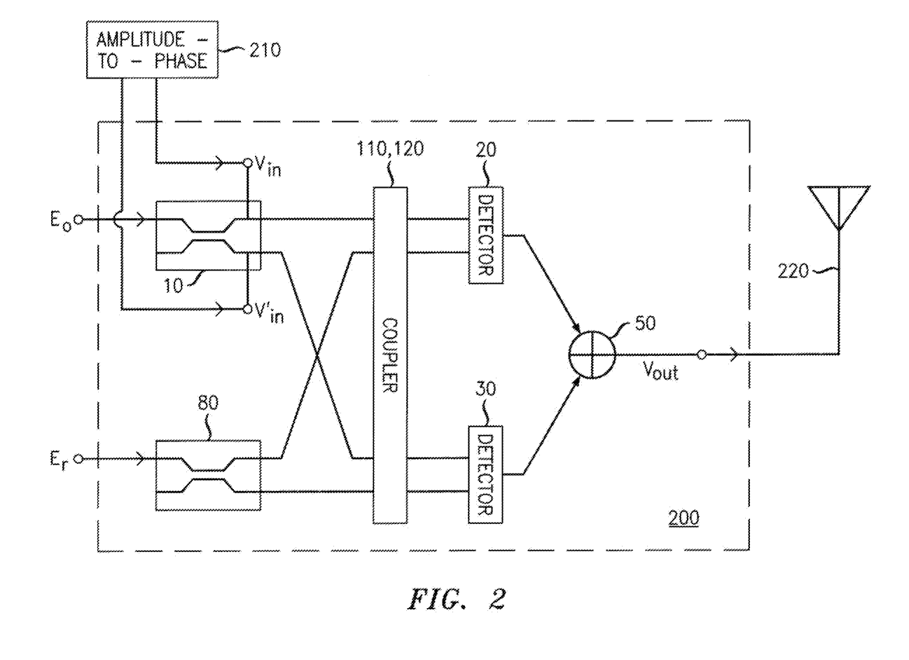

FIG. 2 shows an embodiment of the ideas described above in an exemplary rf transmitter. Amplifier 200 may be, e.g., the optical system as described above, including input ports for the optical carrier signal E₀, optical reference signal Eᵣ, and rf modulation signals Vᵢₙ(t) , V′ᵢₙ(t), and an output port for rf output signal Vₒᵤₜ. Also shown in FIG. 2 is amplitude-to-phase converter 210, which performs the conversion from a(t) to φ(t), and thus provides the rf modulation signals. It is advantageous to perform the amplitude-to-phase conversion digitally, and thus converter 210 may conveniently be implemented in a digital signal processor, although any of various analog and digital implementations may equivalently be used. As shown in the figure, the rf output Vₒᵤₜ is applied to antenna 220 for transmission.

The optical medium for amplifier 200 may comprise optical fiber, planar waveguides, or a combination of the two. In some implementations it may be advantageous to employ discrete optical components for the modulator, couplers, and phase shifters. In other implementations, it may be advantageous to integrate some or all of these functions on a single substrate.

System gain may be adjusted optically or electrically. Optical amplification is advantageous because it typically does not degrade the bandwidth response of the system, but it may have the disadvantage of adding noise. By contrast, electrical amplification typically has better noise properties but may tend to degrade the bandwidth response. Thus, design of systems for specific applications may involve a tradeoff between both modes of amplification.

Optical methods for adjusting the system gain may include changing the carrier amplitude, the reference amplitude, or both. Such methods may also include employing an optical amplifier inserted between modulator 10 and detectors 20, 30. An optical amplifier may, for example, be a Raman amplifier or a rare-earth doped fiber amplifier. Electrical methods of amplification may include the use of a radiofrequency amplifier inserted between detectors 20, 30 and rf combiner 50.

1-6. (canceled)

7. Apparatus comprising:
an optical phase modulator configured to receive an optical carrier signal as input, and to produce as output, when driven by a radiofrequency modulation signal, a complementary pair of phase-modulated optical signals in which the respective phase modulations are opposite in sign;
a pair of detectors, each configured to convert a respective one of the complementary phase-modulated optical signals to a radiofrequency signal; and
an RF combiner configured to form an output signal by combining the converted radiofrequency signals from the detectors.

8. Apparatus of claim 7, wherein the modulator is configured to apply the radiofrequency modulation signal to the optical carrier signal as a differential pair of complementary radiofrequency signals.

9. Apparatus of claim 7, further comprising a medium arranged to guide the complementary optical signals from the modulator to the detectors.

10. Apparatus of claim 9, wherein the medium is configured to bring the complementary optical signals into phase at the detectors.

11. Apparatus of claim 9, further comprising at least one component configured to admit an optical reference signal to the medium, such that at the detectors, each of the complementary optical signals is combined with the optical reference signal.

12. Apparatus of claim 7, further comprising an amplitude-to-phase converter configured to provide a phase-converted signal as the radiofrequency modulation signal for driving the optical phase modulator.

13. Apparatus of claim 12, wherein:
the amplitude-to-phase converter is configured to convert a transmitter input signal to the phase-converted signal; and
the apparatus is configured such that adding the converted radiofrequency signals from the detectors produces a recovered version of the transmitter input signal that is suitable for wireless radiofrequency transmission.

14. Apparatus of claim 12, wherein:
the amplitude-to-phase converter is configured to convert an amplifier input signal to the phase-converted signal; and
the apparatus is configured as an amplifier for the amplifier input signal.

15. Apparatus of claim 7, wherein the RF combiner is configured to add the converted radiofrequency signals from the detectors.
